(19) United States
(12) Patent Application Publication
(10) Pub. No.: US 2015/0117665 A1
(43) Pub. Date: Apr. 30, 2015

(54) Personal Audio Device

(71) Applicant: Alvaro Morillo García, Alacuas (Valencia) (ES)

(72) Inventor: Alvaro Morillo García, Alacuas (Valencia) (ES)

(21) Appl. No.: 14/515,670

(22) Filed: Oct. 16, 2014

(30) Foreign Application Priority Data
Oct. 31, 2013 (ES) 201331252

(51) Int. Cl. H04R 1/02; H04B 1/034

(52) U.S. Cl. CPC H04R 1/025; H04B 1/0343
USPC 381/77

(57) ABSTRACT

A personal audio device includes a body which internally includes at least two speakers, a control mechanism, a wireless electrical connecting device, a battery to power the personal audio device, a charging mechanism for the battery, and a magnet integrated into the body. The control mechanism includes at least a microprocessor, an equalizer, an amplifier, an internal memory for storing of audio files, and a plurality of buttons for connection and control of the personal audio device.

### THE OBJECT OF THE INVENTION

The object of this utility model is a personal audio device of the kind used as a music player during physical and/or sports activities.

### BACKGROUND OF THE INVENTION

At present, when a person prepares to listen to music, for example, it has to be done through an audio source connected to earphones, which will then have to be fastened either to the user's clothes or carried in some kind of storage space (such as a case for the device, a bag, etc.)

The problem of where to carry the audio device becomes even more burdensome when we want to use the device while doing physical activities, given that it is uncomfortable to carry the case or bag, as these are generally not well-suited to physical activities.

As a solution for this problem, there exist a number of cases and/or holders for the audio device which in most cases leave the earphone cables free in the air. This causes certain discomfort, for example when the user is running.

On the other hand, using earphones during the physical activity isolates the user from their surroundings, as they have their ear canals blocked on one hand, and on the other the volume of the earphones tends to be relatively high in order to hear the sound of the device with enough clarity. Thus we have a user who can only hear what is being reproduced by the audio device, isolated from their surroundings. This can prevent them from hearing a beep coming from a vehicle, for example, as well as other warning sounds which could alert the user to danger. In other words, the user runs a greater risk of suffering an accident, given that they cannot hear what is happening in their surroundings. On the other hand, the user can suffer damage to their hearing due to the saturation caused by the excessive volume of the earphones during a prolonged period of time.

### SUMMARY OF THE INVENTION

The technical problem which this invention solves is to obtain a personal audio device which does not require the use of earphones in open spaces, enabling the user to be attentive of their surroundings. To this end, the personal audio device which is the object of this utility model comprises a body consisting of at least two speakers, a control mechanism, a Bluetooth® device, a battery to power the whole, and a charging mechanism, and finally a magnet so that the device can move while in use.

Thanks to its special design, the wearer or user of this device can use it comfortably both in closed spaces (with earphones, in order not to bother other people) and open spaces, being able to pay closer attention to their surroundings.

Throughout the description and the claims, the word “comprises” and its variations do not mean to exclude other technical characteristics, additions, components or steps. For the experts on the subject, other objects, advantages and characteristics of the invention can be deduced partly from the description and partly from the practical side of the invention. The following examples and drawings are provided to serve as illustrations, and do not intend to restrict the invention.

Additionally, the invention covers all the potential combinations of the particular and preferred embodiments indicated here.

### BRIEF DESCRIPTION OF THE FIGURES

The following is a very brief description of a series of drawings which help to understand the invention better, which are explicitly related to an embodiment of the invention, and which are presented as an example but not limited by it.

FIG. 1 shows a simplified view of the elements which define the personal audio device, the object of this utility model.

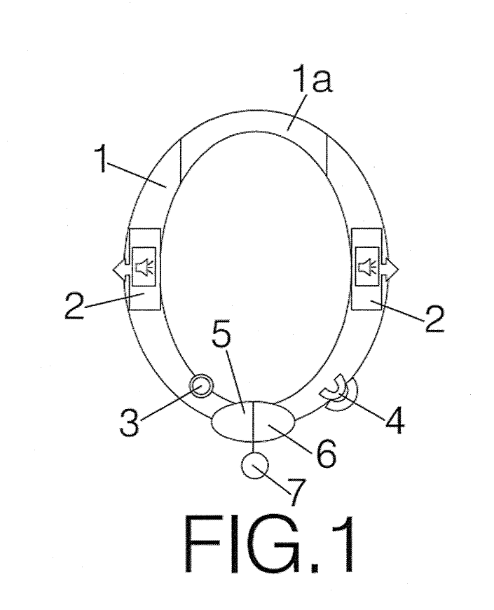

FIG. 2 shows a view of the personal audio device in use.

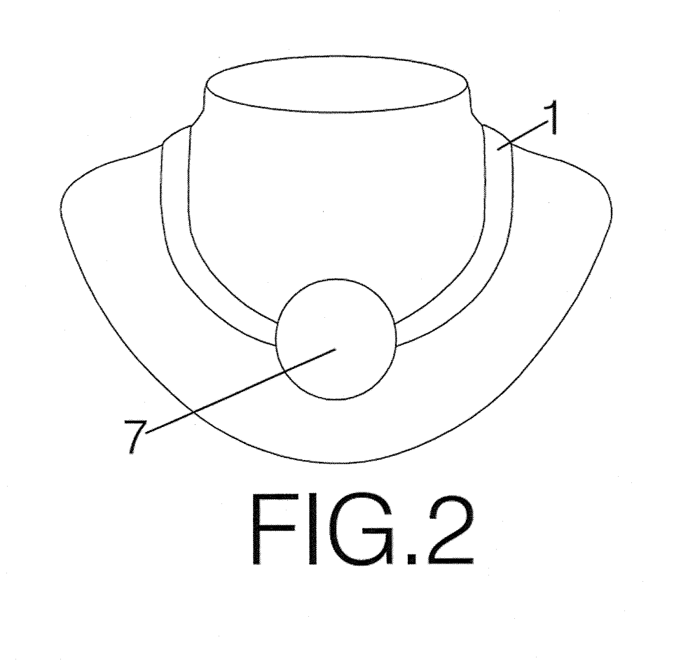

FIG. 3 shows a sectional view of the device.

FIG. 4 shows another practical embodiment of the advocated device, in which it includes a type of clasp.

### PREFERRED EMBODIMENT OF THE INVENTION

The figures show a preferred embodiment of the invention. More specifically, the personal audio device presented in this document comprises a body (1) which consists of at least two speakers (2), a control mechanism, a Bluetooth® device (4), a battery (5) to power the whole, and a charging mechanism (6), a usb or such.

The body (1) includes an integrated magnet (7), which prevents the body (1) from moving with the movement of the user.

The control mechanism consists of at least one microprocessor (3), an equalizer, an amplifier, a transistor, an internal memory for the storing of audio files; and a series of buttons for the connection and control of the device, which are used to turn the device on and/or off as well as to manage the audio files (to activate, stop and move between them etc.)

In a preferred embodiment, the body (1) has an extendible part (la) to facilitate its positioning and use.

The body (1) is preferably made of hypoallergenic silicone, without dismissing other materials like carbon fibre, pvc, metal, glass, gel or such.

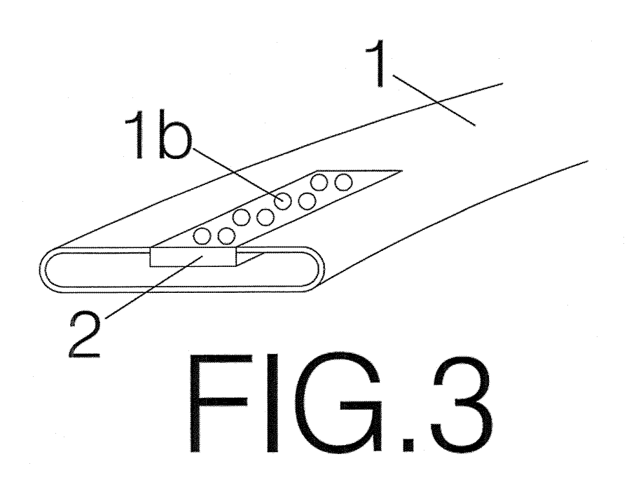

On the other hand, the body (1) has a series of micro-perforations (lb) on the surface which covers the speakers (2) to facilitate audio emission, as shown in FIG. 3.

In a particular embodiment, the body (1) includes at least one entry, a jack or such, for the connecting of earphones, particularly useful for the use of the device in closed spaces. When the earphones are connected, the speakers are disabled.

In a second particular embodiment, the device includes a GPS module to locate the device while in use, for example in sports competitions and/or in case of loss or theft; and/or a module for SIM card for telephonic connection.

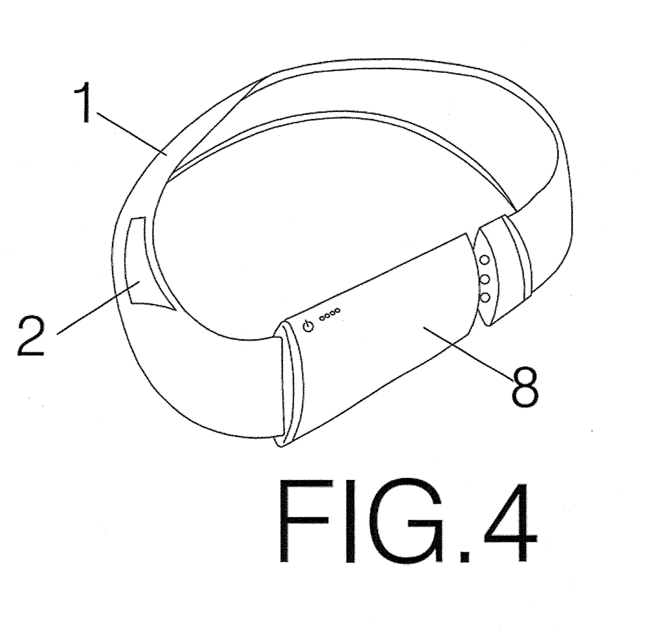

In addition, in a third particular embodiment the body (1) can be opened, and includes a type of clasp (8) which joins the ends of the body (1), as shown in FIG. 4.

In a fourth particular embodiment of the invention, the body (1) includes an internal voice recognition module, connected to the control mechanism, in order to control the device without the need to use the buttons.

What is claimed is:

1. A personal audio device comprising a body which internally includes:
at least two speakers,
a control mechanism,
a wireless electrical connecting device,
a battery to power the personal audio device,
a charging mechanism for the battery, and
a magnet integrated into the body.

2. A device in accordance with claim 1 wherein the control mechanism includes at least:
a microprocessor,
an equalizer,
an amplifier,
an internal memory for storing of audio files, and
a plurality of buttons for connection and control of the personal audio device.

3. A device in accordance with claim 1 wherein the body includes an extendible part.

4. A device in accordance with claim 1 wherein the body includes at least one entry connection to connect earphones.

5. A device in accordance with claim 1 wherein the body includes an internal GPS module.

6. A device in accordance with claim 1 wherein the control mechanism includes a transistor.

7. A device in accordance with claim 1 wherein the body includes an internal module for a SIM card.

8. A device in accordance with claim 1 wherein the body includes an internal voice recognition module.

9. A device in accordance with claim 1 wherein the body is divided into two parts and includes a type of clasp which joins ends of the body.
